(19) United States
(12) Patent Application Publication
(10) Pub. No.: US 2026/0044794 A1
(43) Pub. Date: Feb. 12, 2026

(54) REMOTE OPERATION NOTIFICATION SYSTEM AND REMOTE OPERATION NOTIFICATION METHOD

(71) Applicant: FUJI CORPORATION, Chiryu (JP)

(72) Inventor: Yoshiharu TANIZAWA, Toyota-shi (JP)

(73) Assignee: FUJI CORPORATION, Chiryu (JP)

(21) Appl. No.: 18/998,912

(22) PCT Filed: Sep. 12, 2022
(86) PCT No.: PCT/JP2022/034063

§ 371 Date: Jan. 27, 2025

(51) Int. Cl. G06Q 10/0631

(52) U.S. Cl. CPC G06Q 10/063114

(57) ABSTRACT

A remote operation notification system includes a determination section and a notification section. The determination section is configured to determine whether there is a remote operation performed by a worker of a board work machine configured to perform predetermined board work on a board. The notification section is configured to give a notification of the remote operation performed by a specific worker of the board work machine, who is the worker who performs the remote operation on the board work machine, to at least a general worker, who is the worker other than the specific worker, among the specific worker and the general worker when the determination section determines that there is the remote operation.

### TECHNICAL FIELD

The present description discloses a technique relating to a remote operation notification system and a remote operation notification method.

### BACKGROUND ART

A component mounting system described in PTL 1 includes an operation right setting section and an error type determination section. The operation right setting section sets, for a management device, a remote operation right for enabling a remote operation of a processing device through an input section provided in the management device. The error type determination section determines a type of an error that occurs in the processing device. Further, the error type determination section determines whether an error that occurs in the processing device is a remote handling error which is an error of a target handled through the remote operation performed by the management device, and the operation right setting section sets the remote operation right for the management device when the error is the remote handling error.

### CITATION LIST

### Patent Literature

Patent Literature 1: JP-A-2017-143167

### BRIEF SUMMARY

### Technical Problem

When a specific worker performs a remote operation on a board work machine, a general worker other than the specific worker may perform work in the board work machine, and safety may decrease. In addition, both the specific worker and the general worker may perform duplicate work. Further, the general worker may move to the board work machine in order to perform work in the board work machine. In this way, when duplicate work is performed and unnecessary movement of the general worker occurs, work efficiency may decrease.

In view of such circumstances, the present description discloses a remote operation notification system and a remote operation notification method with which it is possible to improve safety and work efficiency in a remote operation of a board work machine.

### Solution to Problem

The present description discloses a remote operation notification system including a determination section and a notification section. The determination section is configured to determine whether there is a remote operation performed by a worker of a board work machine configured to perform predetermined board work on a board. The notification section is configured to give a notification of the remote operation performed by a specific worker of the board work machine, who is the worker who performs the remote operation on the board work machine, to at least a general worker, who is the worker other than the specific worker, among the specific worker and the general worker when the determination section determines that there is the remote operation.

In addition, the present description discloses a remote operation notification method including a determination step and a notification step. In the determination step, it is determined whether there is a remote operation performed by a worker of a board work machine configured to perform predetermined board work on a board. In the notification step, a notification of the remote operation performed by a specific worker of the board work machine, who is the worker who performs the remote operation on the board work machine, is given to at least a general worker, who is the worker other than the specific worker, among the specific worker and the general worker when the it is determined in the determination step that there is the remote operation.

### Advantageous Effects

With the remote operation notification system described above, it is possible to give a notification of the remote operation to at least the general worker among the specific worker and the general worker when the remote operation is performed on the board work machine. As a result, the remote operation notification system can suppress work of the general worker in the board work machine, and can improve safety. In addition, the remote operation notification system can suppress duplicate work of the general worker and movement of the general worker to the board work machine, and can improve work efficiency. The above description of the remote operation notification system can be similarly applied to the remote operation notification method.

### BRIEF DESCRIPTION OF DRAWINGS

FIG. 1 is a configuration diagram illustrating a configuration example of a production line.

FIG. 2 is a plan view illustrating a configuration example of a component mounter.

FIG. 3 is a block diagram illustrating an example of a control block of a remote operation notification system.

FIG. 4 is a flowchart (first half) illustrating an example of a control procedure of the remote operation notification system.

FIG. 5 is a flowchart (second half) illustrating the example of the control procedure of the remote operation notification system.

### DESCRIPTION OF EMBODIMENTS

### 1. Embodiments

### 1-1. Configuration Example of Production Line WL0

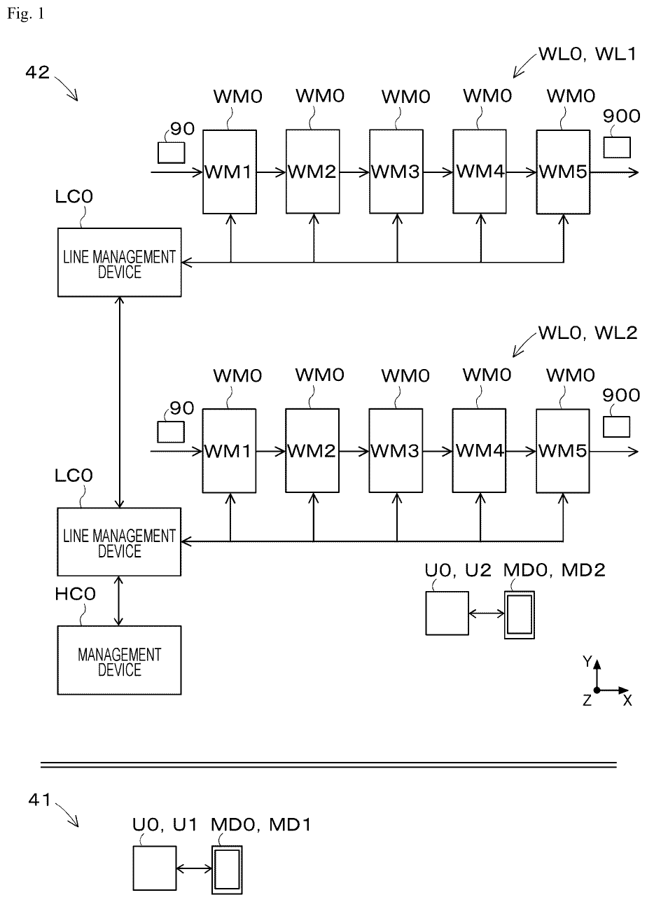

Remote operation notification system 50 can be applied to at least one production line WL0 including board work machine WM0 on which a remote operation is performed. As illustrated in FIG. 1, a production facility according to an embodiment includes two production lines WL0, that is, first production line WL1 and second production line WL2.

In each of two production lines WL0, board work machine WM0 performs predetermined board work on board 90. The type and number of board work machines WM0 configuring production line WL0 are not limited. As shown in FIG. 1, production line WL0 according to the embodiment includes multiple board work machines WM0, which are printer WM1, printing inspector WM2, component mounter WM3, reflow oven WM4, and visual inspector WM5, and board 90 is conveyed in an order described above by a board conveyance device.

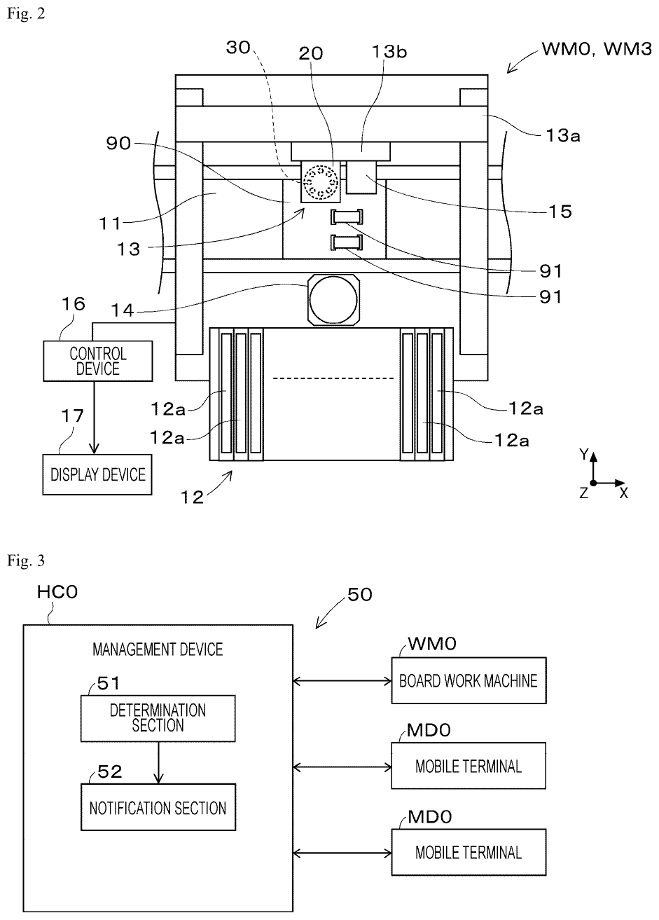

Printer WM1 prints solder on mounting positions of multiple components 91 of board 90. Printing inspector WM2 inspects a print state of the solder which is printed by printer WM1. As illustrated in FIG. 2, component mounter WM3 mounts multiple components 91 on board 90 on which the solder is printed by printer WM1. One or multiple component mounters WM3 may be provided. When multiple component mounters WM3 are provided, multiple component mounters WM3 can share jobs to mount multiple components 91.

Reflow oven WM4 heats board 90 on which multiple components 91 are mounted by component mounter WM3, causes the solder to melt, and performs soldering. Visual inspector WM5 inspects a mounting state or the like of multiple components 91 which are mounted by component mounter WM3. In this way, production line WL0 can convey board 90 in the order using multiple board work machines WM0 and execute a production process including an inspection process to thereby produce board product 900. Production line WL0 may include board work machines WM0 such as a function inspector, a buffer device, a board supply device, a board reversing device, a shield mounting device, an adhesive applying device, and an ultraviolet ray irradiation device as needed.

Multiple board work machines WM0, which configure production line WL0, and line management device LC0 are connected to be capable of communicating with each other via a communication section. Line management device LC0 and management device HC0 are also connected to be capable of communicating with each other via the communication section. The communication section can communicably connect them via wired or wireless communication, and a communication method can take various methods.

In the embodiment, a local area network (LAN) includes multiple board work machines WM0, line management device LC0, and management device HC0. As a result, multiple board work machines WM0 can communicate with one another other via the communication section. In addition, multiple board work machines WM0 can communicate with line management device LC0 via the communication section. In addition, line management device LC0 and management device HC0 can communicate with each other via the communication section.

The line management device LC0 controls multiple board work machines WM0 configuring production line WL0 and monitors an operation status of production line WL0. Line management device LC0 stores various types of control data for controlling multiple board work machines WM0. Line management device LC0 transmits control data to each of multiple board work machines WM0. In addition, each of multiple board work machines WM0 transmits its operation status and production status to line management device LC0.

The management device HC0 manages at least one (two in FIG. 1) line management device LC0. For example, the operation status and production status of board work machine WM0 acquired by line management device LC0 are transmitted to management device HC0 as needed. A storage device is provided in management device HC0. The storage device can store various types of acquired data acquired by board work machine WM0. For example, various types of image data imaged by board work machine WM0 are included in the acquired data. A record (log data) of a working status acquired by board work machine WM0 is included in the acquired data. In addition, the storage device can store various types of production information related to the production of board product 900.

### 1-2. Configuration Example of Component Mounter WM3

Component mounter WM3 mounts multiple components 91 on board 90. As illustrated in FIG. 2, component mounter WM3 includes board conveyance device 11, component supply device 12, component transfer device 13, part camera 14, board camera 15, control device 16, and display device 17.

For example, board conveyance device 11 includes a belt conveyor and the like, and conveys board 90 in a conveyance direction (X-axis direction). Board 90 is a circuit board, on which an electronic circuit, an electrical circuit, a magnetic circuit, and the like are formed. Board conveyance device 11 conveys board 90 into component mounter WM3, and positions board 90 at a predetermined position inside component mounter WM3. After a mounting process of multiple components 91 using component mounter WM3 is ended, board conveyance device 11 conveys board 90 out of component mounter WM3.

Component supply device 12 supplies multiple components 91 to be mounted on board 90. Component supply device 12 includes multiple feeders 12a, which are provided along the conveyance direction (X-axis direction) of board 90. Each of multiple feeders 12a is equipped with a reel. A carrier tape accommodating multiple components 91 is wound around the reel. Feeder 12a feeds the carrier tape pitch by pitch to supply components 91 such that components 91 can be picked up in a supply position positioned at a distal end side of feeder 12a. In addition, component supply device 12 can also supply an electronic component (for example, a lead component or the like) which is relatively large as compared with a chip component or the like in a state of being disposed on a tray.

Component transfer device 13 includes head driving device 13a and moving table 13b. Head driving device 13a is configured to move moving table 13b in the X-axis direction and a Y-axis direction (a direction orthogonal to the X-axis direction on a horizontal plane) using a linear motion mechanism. Mounting head 20 is detachable (replaceable) from moving table 13b by a clamp member. Mounting head 20 picks up and holds component 91 supplied by component supply device 12 by using at least one holding member 30, and mounts component 91 on board 90 positioned by board conveyance device 11. For example, a suction nozzle, a chuck, or the like can be used as holding member 30.

As part camera 14 and board camera 15, a well-known imaging device can be used. Part camera 14 is fixed to a base of component mounter WM3 such that an optical axis is oriented upwards in a vertical direction (a Z-axis direction orthogonal to the X-axis direction and the Y-axis direction). Part camera 14 can capture an image of component 91 held by holding member 30 from below. Board camera 15 is provided on moving table 13b of component transfer device 13 such that an optical axis is oriented downwards in the vertical direction (the Z-axis direction). Board camera 15 can image board 90 from above. Part camera 14 and board camera 15 perform imaging based on a control signal transmitted from control device 16. Image data of the image captured by part camera 14 and board camera 15 is transmitted to control device 16.

Control device 16 includes a well-known computing device and a storage device, and includes a control circuit. The information, image data, and the like output from various sensors provided in component mounter WM3 are input to control device 16. Control device 16 transmits control signals to each device based on a control program, a predetermined mounting condition set in advance, and the like.

For example, control device 16 causes board camera 15 to image board 90 positioned by board conveyance device 11. Control device 16 performs image processing on the image captured by board camera 15 to recognize a positioning state of board 90. Also, control device 16 causes holding member 30 to pick up and hold component 91 supplied by component supply device 12, and causes part camera 14 to image component 91 held by holding member 30. Control device 16 performs the image processing on the image captured by part camera 14 to recognize a holding posture of component 91.

Control device 16 moves holding member 30 toward above a planned mounting position that is set in advance by the control program or the like. Further, based on the positioning state of board 90, the holding posture of component 91, and the like, control device 16 corrects the planned mounting position to set the mounting position on which component 91 is actually mounted. The planned mounting position and the mounting position include a rotation angle in addition to the position (X-axis coordinate and Y-axis coordinate).

Control device 16 corrects a target position (the X-axis coordinate and the Y-axis coordinate) and the rotation angle of holding member 30 according to the mounting position. Control device 16 lowers holding member 30 at the corrected rotation angle at the corrected target position to mount component 91 on board 90. Control device 16 repeats the pick-and-place cycle described above to execute the mounting process of mounting multiple components 91 on board 90.

As display device 17, for example, a well-known display device such as a liquid crystal display can be used, and various types of information can be displayed to worker U0. In addition, in the embodiment, display device 17 is made up of a touch panel and also functions as an input device for receiving various operations by worker U0.

### 1-3. Configuration Example of Remote Operation Notification System 50

As illustrated in FIG. 1, the production facility according to the embodiment includes remote room 41 and production room 42. Remote room 41 is partitioned from production room 42 including at least one (two in the present figure) production line WL0, and worker U0 can perform a remote operation on board work machine WM0 of production line WL0 from remote room 41. In the present description, for convenience of description, worker U0 who performs the remote operation on board work machine WM0 is referred to as specific worker U1, and worker U0 other than specific worker U1 is referred to as general worker U2.

When specific worker U1 performs the remote operation on board work machine WM0, there is a possibility that general worker U2 performs work on board work machine WM0, and safety may decrease. In addition, there is a possibility that both specific worker U1 and general worker U2 perform duplicate work. Further, there is a possibility that general worker U2 moves to board work machine WM0 in order to perform work in board work machine WM0. In this way, when duplicate work is performed and useless movement of general worker U2 occurs, work efficiency may decrease.

The production facility according to the embodiment is provided with remote operation notification system 50. When the remote operation is performed on board work machine WM0, remote operation notification system 50 gives notification of the remote operation to at least general worker U2 among specific worker U1 and general worker U2. Accordingly, remote operation notification system 50 can improve safety and work efficiency in the remote operation of board work machine WM0.

Remote operation notification system 50 includes determination section 51 and notification section 52 as a control block. Remote operation notification system 50 can be provided in various control devices. For example, remote operation notification system 50 may be provided in line management device LC0, management device HC0, or the like. Remote operation notification system 50 may be formed on a cloud. As illustrated in FIG. 3, in remote operation notification system 50 according to the embodiment, determination section 51 and notification section 52 are provided in management device HC0.

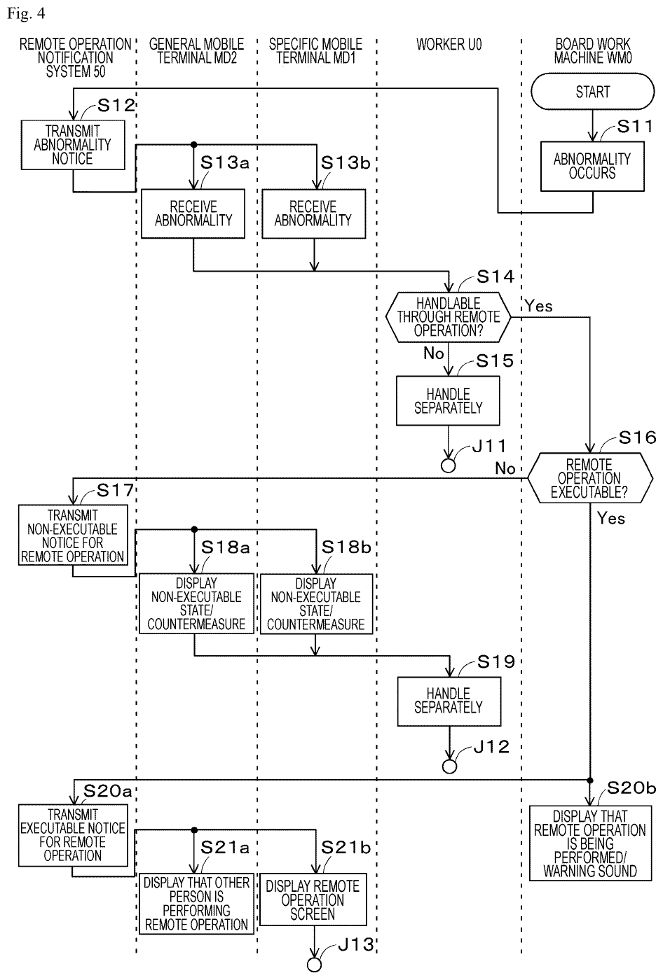

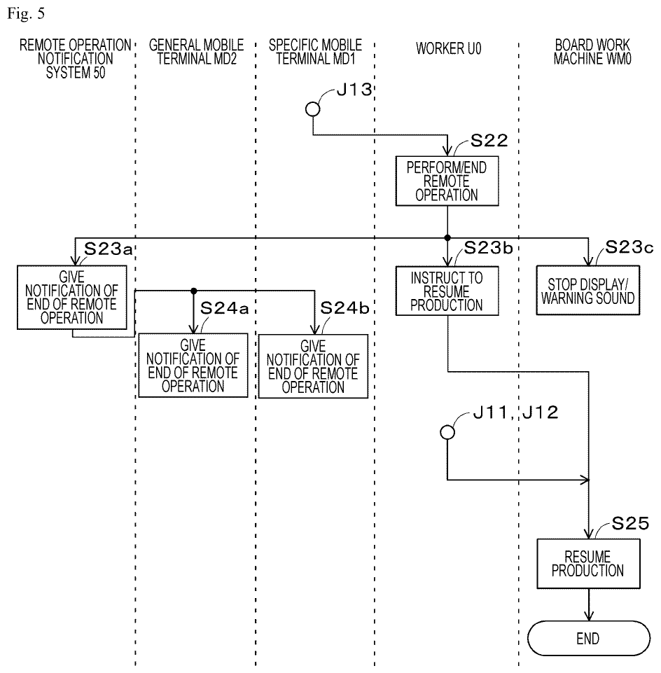

Remote operation notification system 50 according to the embodiment performs control according to flowcharts illustrated in FIGS. 4 and 5. In these figures, processing and determination performed by each of remote operation notification system 50, general mobile terminal MD2 held by general worker U2, specific mobile terminal MD1 held by specific worker U1, worker U0, and board work machine WM0 are divided by broken lines. In the present description, determination section 51 and notification section 52 of remote operation notification system 50 are described with reference to the flowcharts illustrated in FIGS. 4 and 5.

Worker U0 can perform various remote operations on board work machine WM0. For example, the remote operation of board work machine WM0 includes at least one of handling work for handling an abnormality occurring in board work machine WM0, maintenance work of board work machine WM0, and preparation work for board work machine WM0.

For example, when a temporary abnormality occurs in board work machine WM0, worker U0 may cancel the abnormality and resume the production. When a result of image processing of an image obtained by imaging component 91 held by holding member 30 by part camera 14 is abnormal, worker U0 may edit shape data of component 91. In addition, when a printing defect is determined by printing inspector WM2, worker U0 may adjust control parameters of printer WM1 such as a printing pressure and a printing speed of solder. The work as described above is included in the handling work for handling the abnormality occurring in board work machine WM0.

For example, in order to perform maintenance on holding member 30, worker U0 may instruct replacement of holding member 30 using mounting head 20. Further, in order to maintain a mask of printer WM1, worker U0 may instruct printer WM1 to automatically clean the mask. The work as described above is included in the maintenance work of board work machine WM0. In addition, in order to change a setup of board work machine WM0, worker U0 may instruct an automated guided vehicle to convey members such as component 91 and the solder. The work as described above is included in the preparation work for board work machine WM0.

Worker U0 can perform any of the work described above by performing the remote operation on board work machine WM0. In the embodiment, the case where worker U0 performs the handling work for handling the abnormality occurring in board work machine WM0 through the remote operation is described as an example, but the present disclosure can be similarly applied to other work. Further, the matters described in the present description can be appropriately combined and can be omitted and selected.

Determination section 51 determines whether there is a remote operation performed by worker U0 of board work machine WM0 that performs predetermined board work on board 90. When determination section 51 determines that there is a remote operation, notification section 52 gives a notification of the remote operation performed by specific worker U1 of board work machine WM0 to at least general worker U2 among specific worker U1 and general worker U2. Determination section 51 and notification section 52 may take various forms as long as they can perform the above-described determination and processing.

For example, when a start notice indicating that the remote operation is started is transmitted from worker U0, determination section 51 determines that the remote operation is started, and notification section 52 can start the notification of the remote operation. As illustrated in FIG. 1, specific worker U1 and general worker U2 hold mobile terminal MD0 capable of wirelessly communicating with a device of a production facility. Examples of mobile terminal MD0 include a tablet terminal, a watch terminal, and the like. In the present description, for convenience of description, mobile terminal MD0 held by specific worker U1 is referred to as specific mobile terminal MD1, and mobile terminal MD0 held by general worker U2 is referred to as general mobile terminal MD2.

For example, worker U0 transmits the start notice to determination section 51 using mobile terminal MD0 when the remote operation of board work machine WM0 is started. When determination section 51 receives the start notice, determination section 51 determines that there is a remote operation of board work machine WM0. When the start notices are transmitted from multiple workers U0, determination section 51 receives only the start notice that arrives earliest, and only worker U0 who transmits the start notice earliest can perform the remote operation of board work machine WM0.

In addition, for example, it may be difficult to perform the remote operation depending on the operation state of board work machine WM0 on which the remote operation is performed, for example, when board work machine WM0 is producing board product 900. Then, when the start notice is received from worker U0, board work machine WM0 on which the remote operation is performed can determine whether the remote operation is executable based on the operation state of board work machine WM0. In this case, determination section 51 determines that the remote operation is started when an executable notice indicating that the remote operation is executable is received from board work machine WM0 on which the remote operation is performed.

Specifically, as illustrated in FIG. 4, it is assumed that an abnormality occurs in board work machine WM0 (step S11). When an abnormality occurs in board work machine WM0, the board work machine WM0 transmits an abnormality notice indicating that an abnormality occurs to management device HC0 (remote operation notification system 50) via line management device LC0. The abnormality notice includes a time when an abnormality occurs, identification information (module number) with which it is possible to identify board work machine WM0 in which an abnormality occurs, an abnormality content (error code, error message), and the like.

When remote operation notification system 50 receives the abnormality notice from board work machine WM0, remote operation notification system 50 transmits the abnormality notice to mobile terminal MD0 of predetermined worker U0 related to board work machine WM0 in which the abnormality occurs (step S12). Then, mobile terminal MD0 (specific mobile terminal MD1 and general mobile terminal MD2) receives the abnormality notice (steps S13a and S13b). When mobile terminal MD0 receives the abnormality notice, worker U0 determines whether the abnormality is handlable through the remote operation (step S14).

Meanwhile, there is a case where it is difficult for worker U0 to determine whether the abnormality is handlable through the remote operation. Here, notification section 52 preferably gives a notification of determination information with which whether the handling work for handling an abnormality occurring in board work machine WM0 is handlable through the remote operation is determinable by worker U0. For example, the determination information includes the number of occurrences of the same abnormality as the current abnormality, and notification section 52 can notify mobile terminal MD0 of worker U0 of the number of occurrences.

Accordingly, worker U0 can determine whether the abnormality occurring in board work machine WM0 is temporary (whether the number of occurrence is smaller than the predetermined number of occurrences). As described above, when a temporary abnormality occurs in board work machine WM0 (when the number of occurrence is smaller than the predetermined number of occurrences), worker U0 can cancel the abnormality and resume the production, and can handle the abnormality through the remote operation.

The determination information includes editing the shape data of component 91 when the result of image processing of the image obtained by imaging component 91 held by holding member 30 by part camera 14 is abnormal. The editing of the shape data of component 91 can be performed through the remote operation. Furthermore, the determination information includes adjusting the control parameter of printer WM1 when printing inspector WM2 determines a printing defect. The control parameter can be adjusted through the remote operation.

In addition, the determination information includes kitting of the carrier tape in which component 91 is accommodated when the abnormality occurring in board work machine WM0 (component mounter WM3) is a shortage of component 91. The kitting work of the carrier tape needs to be performed by worker U0 using a kitting device, for example, and it is difficult to handle the kitting work through the remote operation. In this way, since notification section 52 gives the notification of the determination information, worker U0 can easily determine whether the handling work for handling the abnormality occurring in board work machine WM0 is handlable through the remote operation.

The above description of the handling work for handling the abnormality occurring in board work machine WM0 can be similarly applied to the other work described above. That is, notification section 52 can give a notification of determination information with which whether at least one of the handling work for handling an abnormality occurring in board work machine WM0, the maintenance work of board work machine WM0, and the preparation work for board work machine WM0 is handlable through the remote operation is determinable by worker U0. Accordingly, worker U0 can easily determine whether the above-described work is handlable through the remote operation.

When the work is not handlable through the remote operation (No in step S14), worker U0 separately handle the work (step S15). Specifically, worker U0 does not perform the remote operation but directly performs the work on board work machine WM0. In addition, an engineer having a technical level higher than that of worker U0 can handle the work. After handling them, board work machine WM0 resumes the production of board product 900 (joint point J11 and step S25).

When the work is handlable through the remote operation (Yes in step S14), worker U0 transmits the start notice indicating that the remote operation is started to board work machine WM0 on which the remote operation is performed, using mobile terminal MD0. Then, when the start notice is received from worker U0, board work machine WM0 on which the remote operation is performed determines whether the remote operation is executable based on the operation state of board work machine WM0 (step S16). As described above, for example, board work machine WM0 can determine that the remote operation is executable when board product 900 is not being produced, and can determine that the remote operation is not executable when board product 900 is being produced.

When it is determined that the remote operation is not executable (No in step S16), board work machine WM0 transmits a non-executable notice indicating that the remote operation is not executable to remote operation notification system 50. Upon receiving the non-executable notice, remote operation notification system 50 transmits the non-executable notice to mobile terminal MD0 of worker U0 (step S17). When mobile terminal MD0 (specific mobile terminal MD1 and general mobile terminal MD2) receives the non-executable notice, mobile terminal MD0 displays that the remote operation of board work machine WM0 is not executable and a countermeasure for the case (steps S18a and S18b).

In this case, worker U0 separately handles the work (step S19). Specifically, worker U0 does not perform the remote operation but directly performs the work on board work machine WM0. In addition, an engineer having a technical level higher than that of worker U0 can handle the work. Board work machine WM0 resumes the production of board product 900 after the handling (joint point J12 and step S25).

When the remote operation is executable (Yes in step S16), board work machine WM0 transmits the executable notice indicating that the remote operation is executable to remote operation notification system 50. Then, when remote operation notification system 50 receives the executable notice, remote operation notification system 50 transmits the executable notice to mobile terminal MD0 of worker U0 (step S20a). When general mobile terminal MD2 receives the executable notice, general mobile terminal MD2 displays that the other person (specific worker U1) is performing the remote operation (step S21a).

When specific mobile terminal MD1 receives the executable notice, specific mobile terminal MD1 displays a work screen of the remote operation, and enters a state in which specific worker U1 can accept the remote operation of board work machine WM0 (step S21b). Further, board work machine WM0 displays that the remote operation is being performed, and generates a warning sound such as a buzzer sound (step S20b). In this way, notification section 52 can give a notification of the remote operation to at least one (in the embodiment, all) of mobile terminal MD0 held by at least general worker U2 among specific worker U1 and general worker U2, and the board work machine WM0 on which the remote operation is performed.

In addition, notification section 52 can give the notification of the remote operation such that the remote operation is recognizable through at least one of a visual sense, an auditory sense, and a tactile sense of worker U0. For example, notification section 52 can give the notification of the remote operation by displaying the above information on at least one (in the embodiment, all) of the display devices (for example, display device 17 of component mounter WM3) of specific mobile terminal MD1, general mobile terminal MD2, and board work machine WM0. In addition, notification section 52 can also display the above information using a color such as red with which it is possible to alert worker U0.

Further, notification section 52 can also blink the above information to alert worker U0. In addition, notification section 52 can output a warning sound such as a buzzer sound, and can also perform a voice notification on the above information. Further, notification section 52 can also give the notification of the remote operation by vibrating mobile terminal MD2 held by at least general worker U2 among specific worker U1 and general worker U2.

In addition, notification section 52 can give a notification of at least one of worker information on specific worker U1, production line information on production line WL0 in which board work machine WM0 on which the remote operation is performed is provided, and working machine information on board work machine WM0 on which the remote operation is performed. The worker information includes, for example, identification information with which it is possible to identify specific worker U1 (such as an affiliation, the employee number, and a name), information on a skill of specific worker U1 such as a work time, and a history of participation in a work lecture, and the like.

The production line information includes, for example, identification information with which it is possible to identify production line WL0 (in the example illustrated in FIG. 1, the line number for identifying first production line WL1 or second production line WL2), a working status of production line WL0, and the like. Further, the working machine information includes identification information with which it is possible to identify board work machine WM0 (for example, the module number of component mounter WM3), the operation state of board work machine WM0, and the like. The notification of the above information using notification section 52 makes it easier for worker U0 to obtain information on a status of the remote operation of board work machine WM0.

When the remote operation is not started by specific worker U1 within a predetermined time after the notification of the remote operation is given, notification section 52 can give the notification of the remote operation again to specific worker U1. For example, notification section 52 can give the notification of the remote operation again in specific mobile terminal MD1 held by specific worker U1. Accordingly, for example, when specific worker U1 gives priority to other work and forgets the work through the remote operation of board work machine WM0, remote operation notification system 50 can alert specific worker U1.

In addition, notification section 52 can give a notification of prohibition of the remote operation performed by general worker U2 on board work machine WM0 on which the remote operation is performed by specific worker U1. Specifically, notification section 52 gives a notification indicating that the other person (specific worker U1) is performing the remote operation and general worker U2 cannot perform the remote operation on board work machine WM0, on general mobile terminal MD2 held by general worker U2. Further, board work machine WM0 disables the remote operation of general worker U2 using general mobile terminal MD2. In addition, notification section 52 gives a notification indicating that specific worker U1 is performing the remote operation and general worker U2 cannot perform the remote operation on board work machine WM0, on the display device of board work machine WM0 (for example, display device 17 of component mounter WM3).

As a result, remote operation notification system 50 can suppress the work of general worker U2 on board work machine WM0 and improve safety. In addition, remote operation notification system 50 can suppress duplicate work of general worker U2 and movement of general worker U2 to board work machine WM0, and can improve work efficiency. In this way, specific worker U1 performs the remote operation of board work machine WM0, and the handling work for handling the abnormality occurring in board work machine WM0 is ended (joint point J13 and step S22).

When an end notice indicating that the work through the remote operation is ended is transmitted from specific worker U1, determination section 51 determines that the remote operation is ended, and notification section 52 can end the notification of the remote operation. Determination section 51 can determine the end of the remote operation in the same manner as in the case of the start notice. For example, when the work through the remote operation is ended, specific worker U1 transmits the end notice indicating that the remote operation is ended to remote operation notification system 50 using specific mobile terminal MD1. When the end notice is received, determination section 51 determines that there is no remote operation of board work machine WM0, and notification section 52 ends the notification of the remote operation.

Specifically, when the end notice is received, remote operation notification system 50 give the notification of the end of the remote operation to mobile terminal MD0 of worker U0 (step S23a). When the notification of the end of the remote operation is received, mobile terminal MD0 displays the end of the remote operation (steps S24a and S24b). When the work through the remote operation is ended, specific worker U1 instructs to resume the production of board product 900 using specific mobile terminal MD1 (step S23b). Further, board work machine WM0 stops the display indicating that the remote operation is being performed and stops the warning sound such as the buzzer sound (step S23c). Then, board work machine WM0 resumes the production of board product 900 (step S25), and the control through remote operation notification system 50 is temporarily ended.

### 2. Remote Operation Notification Method

The fact described above with respect to remote operation notification system 50 can be similarly applied to a remote operation notification method. Specifically, the remote operation notification method includes a determination step and a notification step. The determination step corresponds to control performed by determination section 51. The notification step corresponds to control performed by notification section 52.

### 3. Example of Effects of Embodiment

With remote operation notification system 50, when the remote operation is performed on board work machine WM0, it is possible to give the notification of the remote operation to at least general worker U2 among specific worker U1 and general worker U2. As a result, remote operation notification system 50 can suppress the work of general worker U2 on board work machine WM0, and can improve safety. In addition, remote operation notification system 50 can suppress duplicate work of general worker U2 and movement of general worker U2 to board work machine WM0, and can improve work efficiency. The above description of remote operation notification system 50 can be similarly applied to the remote operation notification method.

### REFERENCE SIGNS LIST

50: remote operation notification system 51: determination section, 52: notification section, 90: board,
U0: worker, U1: specific worker, U2: general worker, MD0: mobile terminal,
WL0: production line, WM0: board work machine.

1. A remote operation notification system comprising:
a determination section configured to determine whether there is a remote operation performed by a worker of a board work machine configured to perform predetermined board work on a board; and
a notification section configured to give a notification of the remote operation performed by a specific worker of the board work machine, who is the worker who performs the remote operation on the board work machine, to at least a general worker, who is the worker other than the specific worker, among the specific worker and the general worker when the determination section determines that there is the remote operation.

2. The remote operation notification system according to claim 1,
wherein the determination section determines that the remote operation is started, when a start notice indicating that the remote operation is started is transmitted from the worker, and
the notification section starts the notification of the remote operation.

3. The remote operation notification system according to claim 2,
wherein the board work machine on which the remote operation is performed determines whether the remote operation is executable based on an operation state of the board work machine, when the start notice is received from the worker, and
the determination section determines that the remote operation is started, when an executable notice indicating that the remote operation is executable is received from the board work machine on which the remote operation is performed.

4. The remote operation notification system according to claim 2,
wherein the determination section determines that the remote operation is ended, when an end notice indicating that work performed by the remote operation is ended is transmitted from the specific worker, and
the notification section ends the notification of the remote operation.

5. The remote operation notification system according to claim 1,
wherein the notification section gives a notification of determination information with which whether at least one of handling work for handling an abnormality occurring in the board work machine, maintenance work of the board work machine, and preparation work for the board work machine is handlable through the remote operation is determinable by the worker.

6. The remote operation notification system according to claim 1,
wherein the notification section gives the notification of the remote operation in at least one of a mobile terminal held by at least the general worker among the specific worker and the general worker and the board work machine on which the remote operation is performed.

7. The remote operation notification system according to claim 1,
wherein the notification section gives the notification of the remote operation such that the remote operation is recognizable through at least one of a visual sense, an auditory sense, and a tactile sense of the worker.

8. The remote operation notification system according to claim 1,
wherein the notification section gives a notification of at least one of worker information on the specific worker, production line information on a production line in which the board work machine on which the remote operation is performed is provided, and working machine information on the board work machine on which the remote operation is performed.

9. The remote operation notification system according to claim 1,
wherein the notification section gives the notification of the remote operation again to the specific worker when the remote operation is not stared by the specific worker within a predetermined time after the notification of the remote operation is given.

10. The remote operation notification system according to claim 1,
wherein the notification section gives a notification of prohibition of the remote operation performed by the general worker on the board work machine on which the remote operation is performed by the specific worker.

11. A remote operation notification method comprising:
a determination step of determining whether there is a remote operation performed by a worker of a board work machine configured to perform predetermined board work on a board; and
a notification step of giving a notification of the remote operation performed by a specific worker of the board work machine, who is the worker who performs the remote operation on the board work machine, to at least a general worker, who is the worker other than the specific worker, among the specific worker and the general worker when it is determined in the determination step that there is the remote operation.
